(19) United States
(12) Patent Application Publication
(10) Pub. No.: US 2004/0181357 A1
(43) Pub. Date: Sep. 16, 2004

(54) Non-contact style temperature measurement device

(76) Inventors: Simon Tsao, HsinChu (TW); Charles Chang, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/441,202

(22) Filed: May 20, 2003

(30) Foreign Application Priority Data
Mar. 14, 2003 (TW) 92105569

(51) Int. Cl. G01K 1/00

(52) U.S. Cl. 702/130

(57) ABSTRACT

The invention provides a non-contact style temperature measurement device, which utilizes a memory to memorize preset temperatures of a plurality of objects to be measured and their infrared emission rates. These temperatures, such as suitable temperature of bathing water for babies, best temperature for roasting beef, best refrigeration temperature for vegetables, and temperature that can be tolerated by human's skin, are specific values that are hard for people to memorize them. Therefore, a memory is used for memorizing these values, and a selector is used for selecting appropriate values. Also, an input device is used to input any objects to be added in for measurement or to revise the inputted preset temperatures in order to increase the utilization rate, security, and convenience of the temperature measurement device so that the device can become a necessity of daily life.

### BACKGROUND OF THE INVENTION

1. Field of the Invention

The invention relates to a non-contact style temperature measurement device and, more particularly, to a device for measuring temperatures of various objects, which utilizes a memory device to memorize preset temperatures of a plurality of objects to be measured and their infrared emission rates so as to inform users temperature differences.

2. Description of the Related Art

When the temperature of an object is lower than 400 degrees Celsius (400° C.), the electromagnetic waves radiated by the object are mostly infrareds that cannot be detected by human eyes. Conversely, when the object's temperature is higher than 400° C., human eyes can sense the object's radiated dim light in a dark room. As the temperature is getting higher, not only will the intensity of visible light be getting higher, but the color of light will also be turning firstly from dark red (500° C.) to orange, then to yellow, and finally to white. When the temperature reaches 1700° C., red-orange light similar to candle light will be radiated, whereas when the temperature reaches 5800° C., light similar to sunlight will be generated. All objects can radiate infrared energy from their surfaces. The hotter an object, the stronger its radiated energy. An infrared thermometer is to congregate infrared radiant energy from the surface of an object within focal distance of a detector, and then the detected energy is converted into electronic signals. Infrared emission rate of most non-metal materials can approach 0.95, whereas infrared emission rate of general metal materials is far smaller than 0.95. However, a precise emission rate has to be set up for non-contact style temperature measurement device of metal materials; otherwise, a wrong answer may be got from the measurement.

The function of a conventional thermometer is to measure temperature for an object and then display detected temperature only. Therefore, if a user is expecting to obtain an object's most suitable temperature, such as suitable temperature of bathing water for babies, best temperature for roasting beef, best refrigeration temperature for vegetables, and temperature that can be tolerated by human's skin, the user has to memorize the temperature and keep it in mind on his/her own. Knowing suitable temperatures can prevent injury or damage caused by inappropriate temperatures. However, not everyone is able to memorize all the necessary temperatures. In fact, it is a problem that a conventional thermometer is capable of detecting temperature but incapable of determining a most suitable temperature for its users.

Therefore, the invention is to solve the above-mentioned problem and provide a novel non-contact style temperature measurement device to improve the shortcoming of conventional non-contact style thermometer that is incapable of memorizing temperature and emission rate of an object to be measured.

### SUMMARY OF THE INVENTION

The first and main object of the invention is to provide a non-contact style temperature measurement device capable of memorizing preset temperatures and infrared emission rates of a plurality of objects to be measured through a selector and a memory so that it will be convenient for a user to obtain a desired temperature without taking the trouble to memorize any temperatures.

The second object of the invention is to provide a non-contact style temperature measurement device capable of comparing any object's measured temperature with its preset temperature through an addition-and-subtraction calculation comparator so as to help users determine whether the temperature of the object is appropriate.

The third object of the invention is to provide a non-contact style temperature measurement device capable of performing better precision, utilization rate and convenience so that the device can be widely used and become a necessity of daily life, bringing security and convenience to people.

The invention is a non-contact style temperature measurement device, which includes: a non-contact style thermometer for measuring temperatures of objects; a memory for storing preset temperatures and infrared emission rates of a plurality of objects to be measured; a selector for selecting temperatures; and an input device for inputting objects to be added in for measurement or revising inputted preset temperatures and their infrared emission rates.

The objects and technical contents of the invention will be better understood through the description of the following embodiments with reference to the drawings.

### BRIEF DESCRIPTION OF THE DRAWINGS

FIG. 1 is a block schematic diagram of configuration of the invention.

FIG. 2 is a block schematic diagram of another embodiment of the invention.

FIG. 3 is a schematic diagram showing the invention being implemented in real life.

### DESCRIPTION OF THE PREFERRED EMBODIMENTS

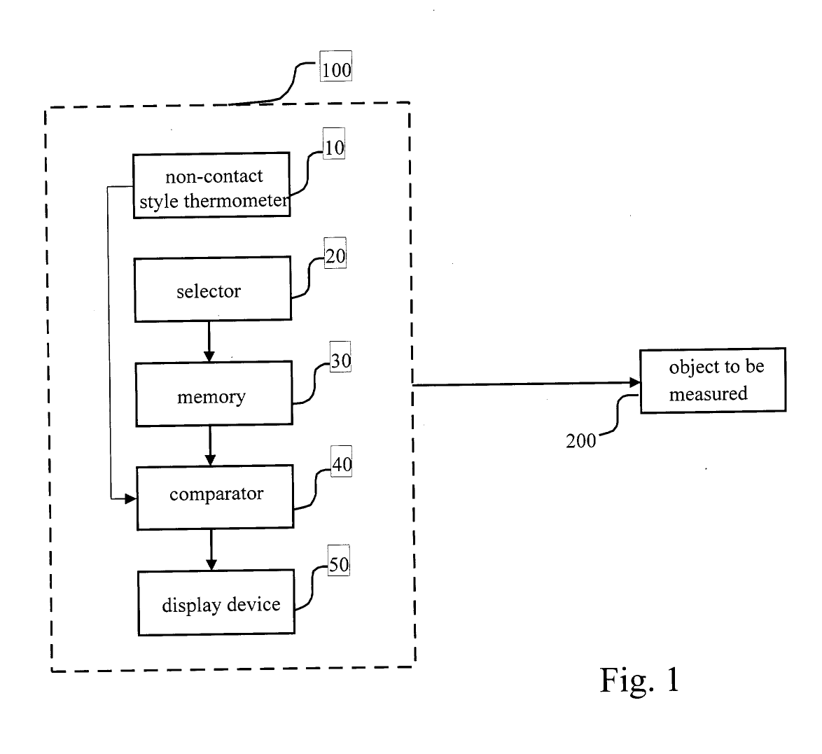

FIG. 1 is a block schematic diagram showing configuration of an embodiment of the invention. Referring to FIG. 1, the invention provides a non-contact style temperature measurement device 100, which includes: firstly, a non-contact style thermometer 10 to measure temperature of an object to be measured 200 and to obtain a measured temperature; secondly, a memory 30 to store a plurality of preset temperatures for objects to be measured and their infrared emission rates therein in advance; thirdly, a selector 20 to select a list of objects to be measured 200 through a user's selection so that preset temperatures of the objects can be extracted from the memory 30; fourthly, a comparator to compare the measured temperature with the preset temperature selected from the memory 30 after the temperature of the object to be measured 200 has been taken from the non-contact thermometer 10 so that temperature difference between the two can be outputted after comparison; finally, a display device 50 to display the measured temperature taken from the non-contact style thermometer 10 and the temperature difference calculated by the comparator 40.

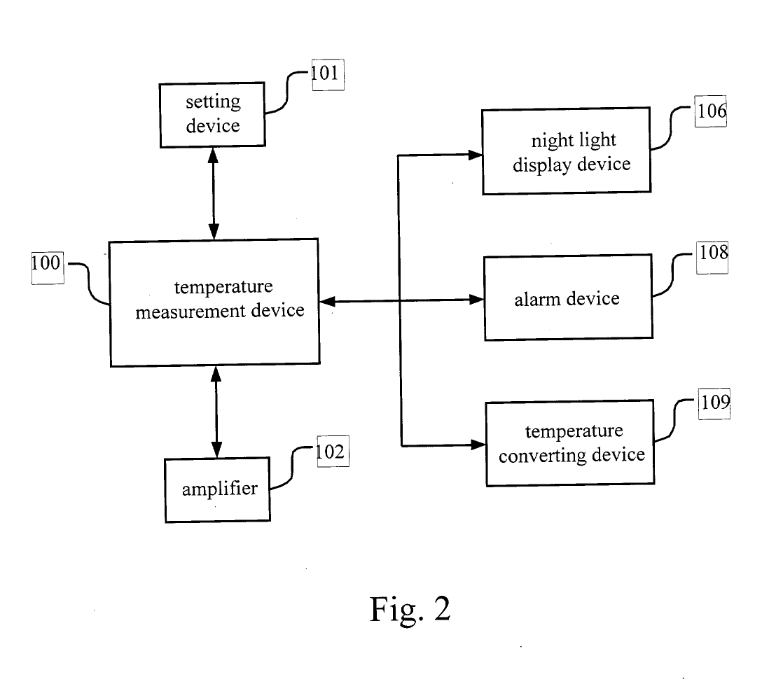

Next, FIG. 2 is a block schematic diagram of another embodiment of the invention. Referring to FIG. 2, the invention also includes a setting device 101 corresponding to the memory 30 for making connections between signals. Besides, the setting device 101 also allows its user to set up preset temperatures and infrared emission rates for various objects and to store all the relative data into the memory 30 to facilitate the selector 20's selecting the object to be measured 200 as well as obtaining its corresponding preset temperature from the memory 30. The temperature measurement device 100 is further connected to a night light display device 106 to display measured temperature despite of dim light. Also, the invention further includes an alarm device 108, which usually is a buzzer. When temperature difference between the measured temperature and the preset temperature is too large, the alarm device 108 will inform its user by a warning message. Additionally, a temperature-converting device 109 is capable of converting a temperature from Celsius scale to Fahrenheit scale or vice versa to facilitate users who only adopt one of the scales for reading temperatures.

Moreover, the foregoing non-contact style thermometer 10 utilizes infrared for temperature measurement, while the list of objects to be measured in the selector 20 can be a plurality of objects, such as a refrigerator, an oven, drinking water, food for cooking, or an external temperature. Besides, a user can input preset temperatures and emission rates that will be stored in the memory 30 through the setting device 101. After that, the comparator 40 does addition-and-subtraction calculation for the measured temperature and the preset temperature, and the difference between the two will be displayed on the display device 50 by using an expression of larger than or smaller than, or an expression of positive value or negative value, or even a range of values. Also, the display device 50 can be a liquid crystal screen or a voice device.

Alternatively, the comparator 40 may not be used in the non-contact style temperature measurement device 100; instead, the measured temperature and the preset temperature can be directly displayed on the display device 50 to be viewed by its user since the calculation between the two is pretty simple and can be handled by its user easily.

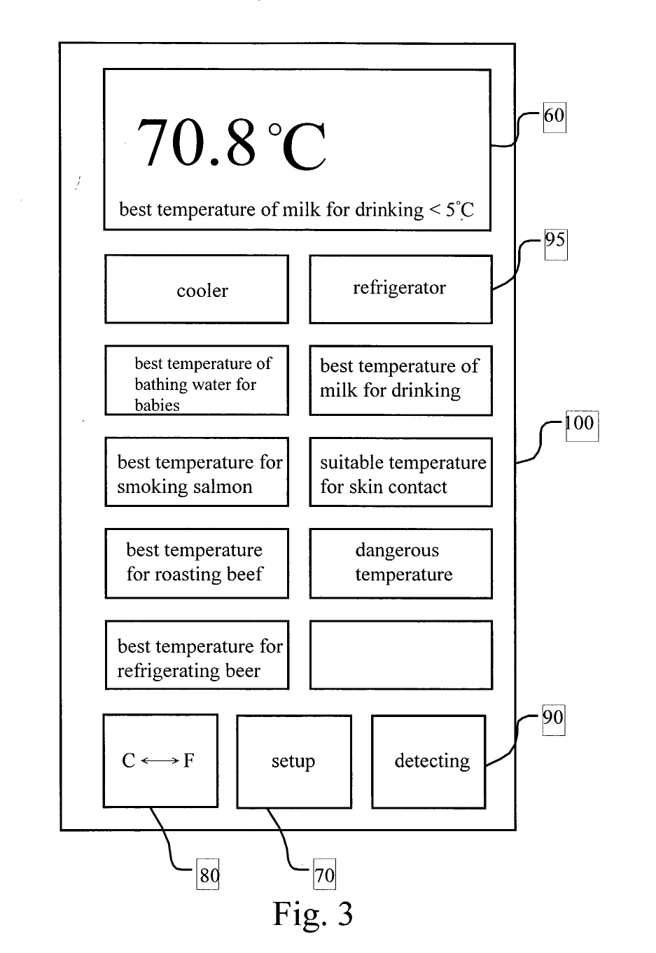

FIG. 3 is a schematic diagram showing the invention being implemented in real life. Referring to FIG. 3, the configuration is primarily composed of a liquid crystal display device 60, a setting button 70, a temperature scale converting button 80, a detect button 90, and a plurality of buttons for objects to be measured 95. When a user using these buttons to select or set up requisite data, the liquid crystal display device 60 will display the selected object, the detected temperature of the object, and the difference between the detected temperature and the preset temperature after calculation. Therefore, it is very convenient for the user to obtain the required difference of selected temperatures without memorizing or recalling any cumbersome numbers.

In conclusion, the invention is a non-contact style temperature measurement device, which utilizes a memory device to store preset temperatures and infrared emission rates of a plurality of objects to be measured so that precise temperature of an object can be calculated and the precise temperature can also be compared to its corresponding measured temperature in order to inform its user temperature difference between the two. The non-contact style temperature measurement device of the invention is capable of performing better precision, utilization rate and convenience so that it can be widely used in daily life to increase people's security and convenience and therefore become a necessity of daily life.

The embodiments above are only intended to illustrate the invention; they do not, however, to limit the invention to the specific embodiments. Accordingly, various modifications and changes may be made without departing from the configuration, characteristics, spirit, and scope of the invention as described in the appended claims.

What is claimed is:

1. A non-contact style temperature measurement device, including:
a non-contact style thermometer, to measure the temperature of an object to be measured and obtain a measured temperature;
a memory, to store preset temperatures of a plurality of objects to be measured therein;
a selector, to select from a list of objects to be measured through a user's selection so that preset temperatures of the objects can be extracted from the memory;
a comparator, to compare the measured temperature taken from the non-contact style thermometer with the selected preset temperature; and
a display device, to display the measured temperature and the temperature difference outputted by the comparator.

2. The non-contact style temperature measurement device as claimed in claim 1, further including a setting device that can set up preset temperatures for objects to be measured and their infrared emission rates and can store relative data into the memory.

3. The non-contact style temperature measurement device as claimed in claim 1, further including a night light display device so that the measured temperature and the temperature difference can still be displayed even though the light is dim.

4. The non-contact style temperature measurement device as claimed in claim 1, wherein the non-contact style thermometer utilizes infrared to perform temperature measurement.

5. The non-contact style temperature measurement device as claimed in claim 1, wherein the list of object to be measured in the selector may include a plurality of objects to be measured, such as a refrigerator, an oven, drinking water, food for cooking, or an external temperature.

6. The non-contact style temperature measurement device as claimed in claim 1, wherein the comparator utilizes a hardware or software to do addition-and-subtraction calculation for the measured temperature and the preset temperature.

7. The non-contact style temperature measurement device as claimed in claim 1, wherein the display device displays temperature difference between the measured temperature and the preset temperature by using an expression of larger than or small than.

8. The non-contact style temperature measurement device as claimed in claim 1, wherein the display device displays temperature difference between the measured temperature and the preset temperature by using an expression of positive value or negative value.

9. The non-contact style temperature measurement device as claimed in claim 1, wherein the display device displays temperature difference between the measured temperature and the preset temperature by using a range of values.

10. The non-contact style temperature measurement device as claimed in claim 1, wherein the display device is either a liquid crystal screen or a voice device.

11. The non-contact style temperature measurement device as claimed in claim 1, further including an alarm device capable of giving its user a warning message when temperature difference between the measured temperature and the preset temperature is too large.

12. The non-contact style temperature measurement device as claimed in claim 11, wherein the alarm device is a buzzer.

13. The non-contact style temperature measurement device as claimed in claim 1, further including a temperature-converting device capable of converting a temperature from Celsius scale to Fahrenheit scale or vice versa.

14. A non-contact style temperature measurement device, including:
a non-contact style thermometer, to measure the temperature of an object to be measured and obtain a measured temperature;
a memory, to store preset temperatures of a plurality of objects to be measured and their infrared emission rates therein;
a selector, to select from a list of objects to be measured through a user's selection so that preset temperatures of the objects can be extracted from the memory; and
a display device, to display the measured temperature taken by the non-contact style thermometer.

15. The non-contact style temperature measurement device as claimed in claim 14, further including a setting device that can set up preset temperatures for objects to be measured and their infrared emission rates and can store relative data into the memory.

16. The non-contact style temperature measurement device as claimed in claim 14, further including a night light display device so that the measured temperature and the temperature difference can still be displayed even though the light is dim.

17. The non-contact style temperature measurement device as claimed in claim 14, wherein the non-contact style thermometer utilizes infrared to perform temperature measurement.

18. The non-contact style temperature measurement device as claimed in claim 14, wherein the list of object to be measured in the selector may include a plurality of objects to be measured, such as a refrigerator, an oven, drinking water, food for cooking, or an external temperature.

19. The non-contact style temperature measurement device as claimed in claim 14, wherein the display device is a liquid crystal screen.

20. The non-contact style temperature measurement device as claimed in claim 14, wherein the display device is a voice device.

21. The non-contact style temperature measurement device as claimed in claim 14, further including an alarm device capable of giving its user a warning message when temperature difference between the measured temperature and the preset temperature is too large.

22. The non-contact style temperature measurement device as claimed in claim 21, wherein the alarm device is a buzzer.

23. The non-contact style temperature measurement device as claimed in claim 14, further including a temperature-converting device capable of converting a temperature from Celsius scale to Fahrenheit scale or vice versa.
